(19) United States
(12) Patent Application Publication
(10) Pub. No.: US 2011/0001999 A1
(43) Pub. Date: Jan. 6, 2011

(54) DATA PROCESSING APPARATUS, CONTROL METHOD FOR DATA PROCESSING APPARATUS, AND RECORDING MEDIUM

(75) Inventor: Yoshihito Nanaumi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/792,511

(22) Filed: Jun. 2, 2010

(30) Foreign Application Priority Data
Jul. 1, 2009 (JP) 2009-156890

(51) Int. Cl. G06F 15/00

(52) U.S. Cl. 358/1.14

(57) ABSTRACT

Provided is a control method for controlling a data processing apparatus that can be connected to an external apparatus via a network. The control method includes obtaining and displaying a user interface held in the external apparatus. An instruction from a user is received via the displayed user interface. The received instructions are transmitted to the external apparatus. A session for communicating with the external apparatus is reserved when authentication of the user manipulating the data processing apparatus has succeeded. The reserved session is used to execute control to receive from the external apparatus a processing request that corresponds to the instruction transmitted to the external apparatus.

### BACKGROUND OF THE INVENTION

1. Field of the Invention

The present invention relates to a data processing apparatus, a control method for a data processing apparatus, and a recording medium.

2. Description of the Related Art

Recently, there is generally known a data processing apparatus having the functions of a printer, a copier, a facsimile, a scanner, etc. An MFP (Multi Function Peripheral) is one example of such a data processing apparatus. In such a data processing apparatus, the functions of a printer, a copier, a facsimile, a scanner, etc. are executed in accordance with an instruction from the user.

Some of those data processing apparatuses include a browser and can access a web server on a network.

Further, there is proposed a method of installing a user interface for operating the data processing apparatus in an external apparatus, e.g., a web server, and allowing the user to utilize the user interface in the web server from the browser in the data processing apparatus.

According to such a method, an instruction input from the browser in the data processing apparatus via the user interface in the external apparatus is received, as a processing request (e.g., a print request) from the exterior, by the data processing apparatus. In some of those data processing apparatuses, only the processing request from an eligible external apparatus can be executed by transferring, e.g., ID information (such as a host name) identifying the external apparatus between the data processing apparatus and the external apparatus. (See Japanese Patent Laid-Open No. 2008-003834).

A system including the above-described data processing apparatus and the external apparatus employs the HTTP (Hyper Text Markup Language) protocol. In the HTTP protocol, the external apparatus establishes connection with the data processing apparatus whenever the data processing apparatus issues the processing request. The external apparatus makes a response to the processing request issued from the data processing apparatus. Upon receiving the response, the data processing apparatus stores, as session information, user log-in information and user information in a session area and cuts off the connection after the end of a series of processes.

In some of those data processing apparatuses, however, memory resources usable to manage the session information are smaller than memory resources in the external apparatus, e.g., a general web server. That data processing apparatus has a limitation in the number of sessions capable of being reserved therein.

That type of data processing apparatus is often connected to a plurality of PCs via a network and, upon receiving processing requests from the plural PCs, it is required to reserve plural sessions in order to respond the processing requests.

For that reason, when, after logging in to the data processing apparatus, the user transmits the processing request to the data processing apparatus from a manipulating portion of the data processing apparatus via the user interface in the external apparatus, the number of sessions manageable by the data processing apparatus is insufficient in some cases. In such a case, due to insufficiency of the sessions, the data processing apparatus cannot normally receive the processing request, and hence an error occurs.

On that occasion, the user cannot recognize the insufficiency of resources to store the session information until the user accesses the external apparatus and transmits the processing request to the data processing apparatus via the user interface in the external apparatus after logging in to the data processing apparatus.

### SUMMARY OF THE INVENTION

The present invention provides a data processing apparatus that can be connected to an external apparatus via a network. The data processing apparatus includes a display unit, a receiving unit, an instruction transmitting unit, a reserving unit, and a control unit. The display unit can obtain and display a user interface held in the external apparatus. The receiving unit can receive, from a user manipulating the data processing apparatus, an instruction via the user interface displayed by the display unit. The instruction transmitting unit can transmit the instruction received by the receiving unit to the external apparatus. The reserving unit can reserve a session for communicating with the external apparatus when authentication of the user manipulating the data processing apparatus has succeeded. The control unit can execute control to receive a processing request. The received processing request corresponds to the instruction transmitted to the external apparatus by the instruction transmitting unit and is received from the external apparatus by using the session reserved by the reserving unit.

Further features of the present invention will become apparent from the following description of exemplary embodiments with reference to the attached drawings.

### BRIEF DESCRIPTION OF THE DRAWINGS

FIG. 1 is a block diagram illustrating one example of an image processing system.

FIG. 2 is a block diagram illustrating a software configuration of an image processing apparatus.

FIG. 3 is a block diagram illustrating a detailed configuration of the image processing apparatus.

FIG. 4 is an external view of the image processing apparatus.

FIG. 5 is an external layout view of a manipulating portion.

FIG. 6 is a block diagram illustrating a detailed configuration of the manipulating portion.

FIG. 7 is a chart illustrating flow of processing of a request and a response in accordance with the HTTP protocol.

FIG. 8 illustrates one example of a UI displayed on a LCD display portion.

FIG. 9 illustrates a data structure of an authentication context in the image processing system.

FIG. 10 is a chart illustrating one example of processing for a WAS.

FIG. 11 is a block diagram illustrating a detailed configuration of a server.

FIG. 12 illustrates a data structure of a session in the image processing system.

FIG. 13 illustrates one example of a log-in screen displayed on the manipulating portion.

FIG. 14 is a flowchart illustrating processing procedures in the image processing system.

FIGS. 15A and 15B are each a flowchart illustrating processing procedures in the image processing system.

FIG. 16 illustrates one example of the UI displayed on the manipulating portion.

FIG. 17 is a flowchart illustrating processing procedures in an image processing system.

FIG. 18 is a flowchart illustrating processing procedures in an image processing system.

FIG. 19 is a flowchart illustrating processing procedures in an image processing system.

### DESCRIPTION OF THE EMBODIMENTS

An embodiment of the present invention will be described below with reference to the drawings.

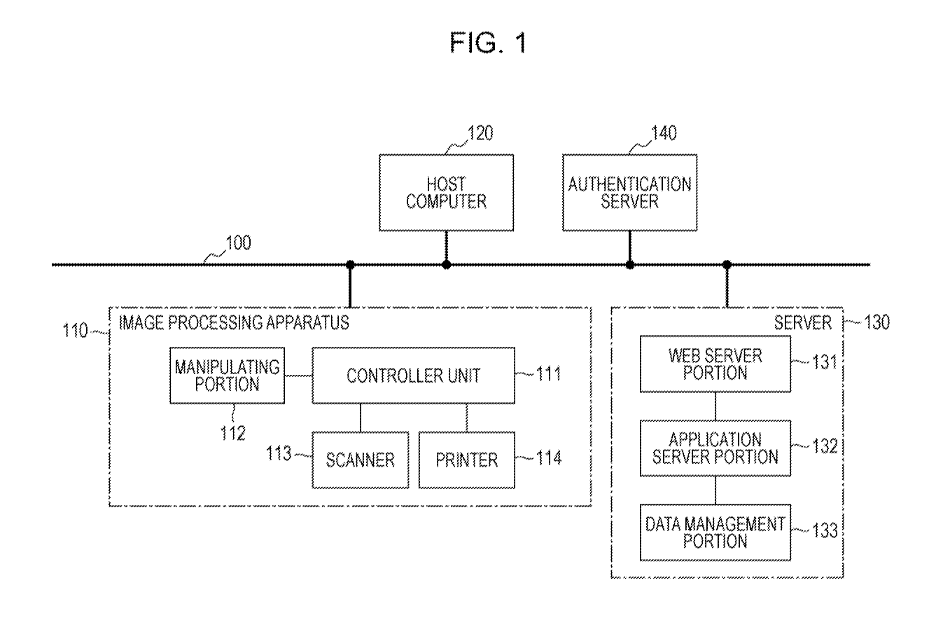

FIG. 1 is a block diagram illustrating a configuration of a data processing system according to the embodiment of the present invention. In the embodiment, an image processing system is described as one example of the data processing system, and an image processing apparatus is described as one example of a data processing apparatus. Also, the embodiment is described in connection with the case where the image processing apparatus is the so-called MFP (Multi Function Peripheral), but the image processing apparatus may be the so-called SFP (Single Function Peripheral).

Referring to FIG. 1, a LAN (Local Area Network) 100 is connected to a WAN (Wide Area Network) or the Internet. A host computer 120 is connected to the LAN 100. The host computer 120 includes a web browser and can receive services via HTTP connection with an image processing apparatus 110 and a server 130.

The server 130 includes a group of software processes for realizing a web application server. The server 130 includes software modules described later. A plurality of apparatuses on a network can access the server 130 and can utilize the functions of the server 130. For example, the host computer 120, the image processing apparatus 110, or some other apparatus (not shown), each being connected to the network, can access the server 130 and can utilize the functions of the server 130.

A web server portion 131 is a module for transferring contents, such as HTML documents, in response to requests issued from clients in accordance with the HTTP protocol. An application server portion 132 is a module installed in the form of, e.g., a CGI (Common Gateway Interface) program or a Servlet, which executes a predetermined process and an HTTP response upon receiving an HTTP request. A data management portion 133 is a module for storing script data called from the application server portion 132 and for storing received data.

An authentication server 140 executes user authentication and user information management for the image processing apparatus 110. More specifically, the authentication server 140 executes the user authentication by employing a Credential, including a user name, a domain name, and a password, which are obtained from the image processing apparatus 110 and the server 130. If the user authentication has succeeded, the authentication server 140 replies by sending a Security Token (hereinafter abbreviated to “ST”) to a source having requested the authentication. In other words, the ST is information that is replied when validity of the Credential has been confirmed and the user authentication has succeeded, i.e., information indicating that the authentication has been completed. Between devices for which the authentication server 140 executes the user authentication, the user authentication is no longer required to be executed by the authentication server 140 again by transferring the ST between those devices. By using the authentication server 140 described above, the user authentication can be executed in a unified manner among devices connected to the LAN 100, and the user can be uniquely identified among those devices.

The image processing apparatus 110 is an MFP (Multi Function Peripheral) for executing inputting/outputting and transmission/reception of an image, as well as various types of image processing. The image processing apparatus 110 includes a scanner 113, i.e., an image input device, a printer 114, i.e., an image output device, a controller unit 111, and a manipulating portion 112.

The scanner 113, the printer 114, and the manipulating portion 112 are connected to the controller unit 111 and are controlled in accordance with commands from the controller unit 111. The controller unit 111 is connected to the LAN 100.

### [Software Configuration of Image Processing Apparatus 110]

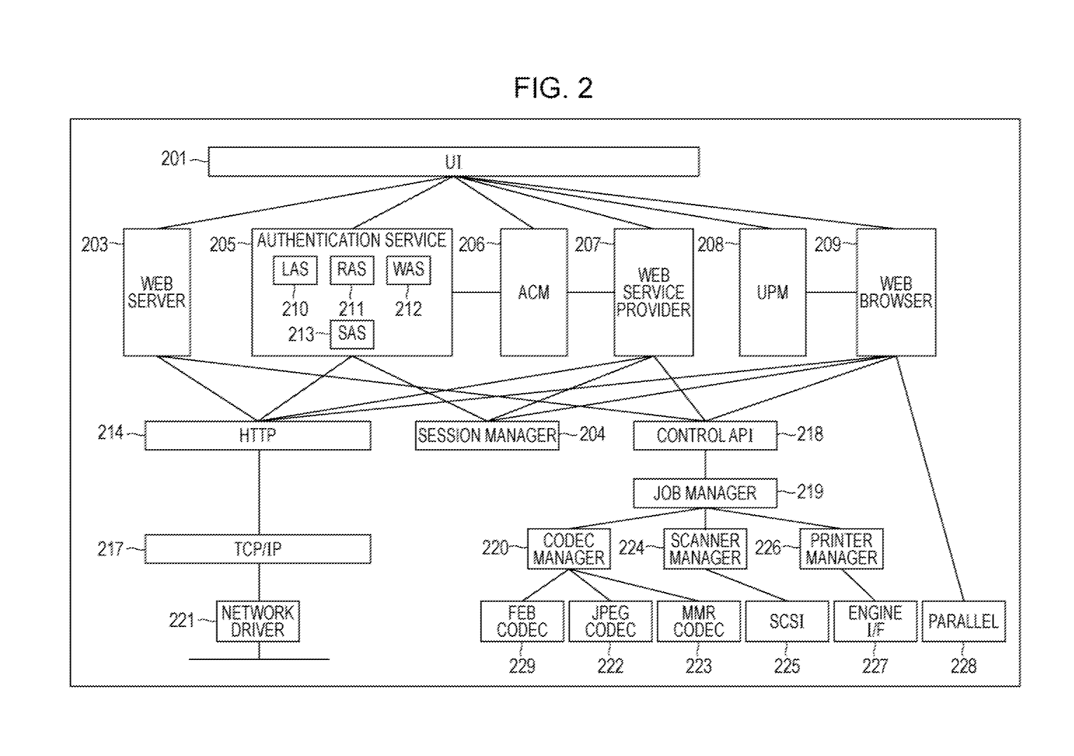

A software configuration of the image processing apparatus 110 will be described below with reference to FIG. 2. FIG. 2 is a block diagram illustrating the software configuration of the image processing apparatus 100 illustrated in FIG. 1.

Referring to FIG. 2, a user interface (hereinafter abbreviated to a “UI”) module 201 is a module for intermediating between a device and a user manipulation when the user (operator) performs various kinds of manipulations and settings on the image processing apparatus 110. In accordance with the user manipulation, the UI module 201 executes, e.g., issuance of a processing request or setting of data by transferring input information to various modules described below.

A Web-Server module 203 receives an HTTP request from a web client (e.g., the host computer 120). Hereinafter, the Web-Server module 203 is simply referred to as the “Web Server 203”. In reply to the HTTP request from the client, the Web Server 203 makes an HTTP response to the web client via an HTTP module 214, a TCP/IP communication module 217, and a Network Driver 221. The response from the Web Server 203 includes, e.g., management information of the image processing apparatus 110.

A Web-Browser module 209 is to read and display various web pages on the Internet or an intranet. The Web-Browser module 209 is simply referred to as the “Web Brower 209” hereinafter and its detailed configuration will be described later.

The HTTP module 214 is used when the image processing apparatus 110 executes HTTP communication. The HTTP module 214 provides the communication function to the Web Server 203, the Web Browser 209, and a Web-Service-Provider module 207 (described later) by using the TCP/IP communication module 217 (described later).

In addition, the HTTP module 214 provides the communication function adaptable for various protocols used on the web, such as the HTTP, in particular a protocol designed with reliable security. The TCP/IP communication module 217 provides the network communication function to the various modules by using the Network Driver 221. The Network Driver 221 is physically connected to the network and controls inputting and outputting of data. An Authentication-Service module 205 manages and controls a user authentication process that is required for the user to utilize the function of the image processing apparatus 110.

A Local-Authentication-Service (LAS) module 210 manages and controls the authentication process for the user authentication that is started to execute from the UI module 201. Hereinafter, the Local-Authentication-Service (LAS) module is abbreviated to the “LAS”. When the LAS 210 receives a Credential input from the UI module 201, it starts the authentication process with the aid of the authentication server 140.

If the authentication method in the authentication server 140 differs, the data communication protocol and the Credential both necessary for the user authentication also differ. Therefore, the LAS 210 is replaceable and the replacement of the LAS 210 makes the image processing apparatus 110 adaptable for various authentication methods that may be used in the authentication server 140. The authentication methods include, for example, the NTLM authentication and the Kerberos authentication. With the replacement of the LAS 210, the authentication also can be executed by a Simple-Authentication-Service module 213 in the image processing apparatus 110 instead of the authentication server 140. Hereinafter, the Simple-Authentication-Service (SAS) module is abbreviated to “SAS”.

Further, with the replacement of the LAS 210, an input can be received in various ways, including an input of the authentication information by using a touch panel or a soft (software) keyboard, and an input of the Credential by using a USB keyboard or a USB card reader.

A Remote-Authentication-Service (RAS) module 211 manages and controls the authentication process for the user authentication that is started to execute from the web client via the Web Server 203. Hereinafter, the Remote-Authentication-Service (RAS) module is abbreviated to “RAS”.

When the RAS 211 receives the Credential from the Web Server 203, it executes the authentication process with the aid of the authentication server 140. The RAS 211 is replaceable similarly to the LAS 210 and the replacement of the RAS 211 makes the image processing apparatus 110 adaptable for various authentication methods that may be used in the authentication server 140.

A Web-Authentication-Service (WAS) module 212 manages and controls the authentication process to utilize the function of the image processing apparatus 110 via a Web-Service-Provider module 207 described later. Hereinafter, the Web-Authentication-Service (WAS) module is abbreviated to “WAS”.

Be it noted that an interface for the WAS 212 to execute the authentication process is laid open as web service to the network.

An Authentication-Context-Management (ACM) module 206 manages not only the ST replied from the authentication server 140 after the user authentication has succeeded, but also the user information that can be obtained from the authentication server 140. Hereinafter, the Authentication-Context-Management (ACM) module is abbreviated to “ACM”. Details of the ACM 206 will be described later.

The Web-Service-Provider module 207 provides, as web service, the device function. The Web-Service-Provider module 207 interprets and executes the command received via the LAN 100. That command can be a command based on the SOAP, for example. Hereinafter, the Web-Service-Provider module is abbreviated to “WSP”.

A User-Profile-Management (UPM) module 208 manages user setting and management information per user. Hereinafter, the User-Profile-Management (UPM) module is abbreviated to “UPM”. The UPM 208 requires the ST in order to obtain the setting information and obtains the setting information of each user by using the ST as an access key. The SAS 213 is a module for executing the user authentication and the user information management in the image processing apparatus 110.

Thus, the Authentication-Service module 205 provides the authentication service such that the authentication is executed with the aid of the authentication server 140 by selecting any of the LAS 210, the RAS 211, and the WAS 212 in a replaceable manner. The Authentication-Service module 205 can also execute the authentication service by selecting the SAS 213 other than the LAS 210, the RAS 211, and the WAS 212.

A Session-Manager module 204 is called from the Web-Server module 203, the Authentication-Service module 205, or the Web-Service-Provider module 207 to execute management and control of sessions. Details of the Session-Manager module 204 will be described later. Hereinafter, the Session-Manager module 204 is abbreviated to “SM 204”. The SM 204 manages later-described sessions and the authentication information, for which the user authentication has succeeded, in a correlated manner.

A Control API 218 provides upstream modules, such as the Web Server 203, the Web Browser 209, and the WSP 207, with an interface to downstream modules, such as a Job Manager 219. As a result, dependency between the upstream and downstream modules can be reduced and liquidity between them can be increased. Hereinafter, the Job-Manager module is simply referred to as the “Job Manager”.

The Job Manager 219 interprets various processes instructed from the above-described various modules via the Control API 218 and provides instructions to later-described modules 220, 224 and 226. In addition, the Job Manager 219 manages in a unified manner those hardware processes that are executed in the image processing apparatus 110.

A CODEC-Manager module 220 manages and controls a process of compressing and decompressing data in various manners among the various processes instructed from the Job Manager 219. Hereinafter, the CODEC-Manager module is simply referred to as the “CODEC Manager”.

An FBE-Encoder module (FEB CODEC) 229 compresses data, which is read through a scanning process, by using the FBE format. In practice, the FEB CODEC 229 compresses data, which is read through the scanning process executed by the Job Manager 219 or a later-described Scanner Manager 224, by using the FBE format.

A JPEG CODEC 222 executes a process of executing JPEG compression of read data and JPEG expansion of print data.

Here, the term “read data” implies data that is obtained with the scanning process executed by the Job Manager 219 or the Scanner Manager 224. In addition, the term “print data” implies print data that is executed by a Print Manager 226.

An MMR CODEC module 223 executes a process of MMR-compressing the read data and MMR-decompressing the print data. The read data includes data that is obtained with the scanning process executed by the Job Manager 219 or the Scanner Manager 224. In addition, the print data includes data that is obtained with the printing process executed by the Print Manager 226.

The Scanner Manager 224 manages and controls the scanning process instructed from the Job Manager 219. Communication between the Scanner Manager 224 and the scanner 113, which is internally connected to the image processing apparatus 110, is performed through a SCSI driver 225.

The Print Manager 226 manages and controls the printing process instructed from the Job Manager 219. Engine I/F 227 provides an interface between the Print Manager 226 and the printer 114.

A parallel port driver (Parallel) 228 is mounted to provide an interface (I/F) for outputting data to an output device (not shown) via the Parallel 228.

### [Detailed Configuration of Image Processing Apparatus 110]

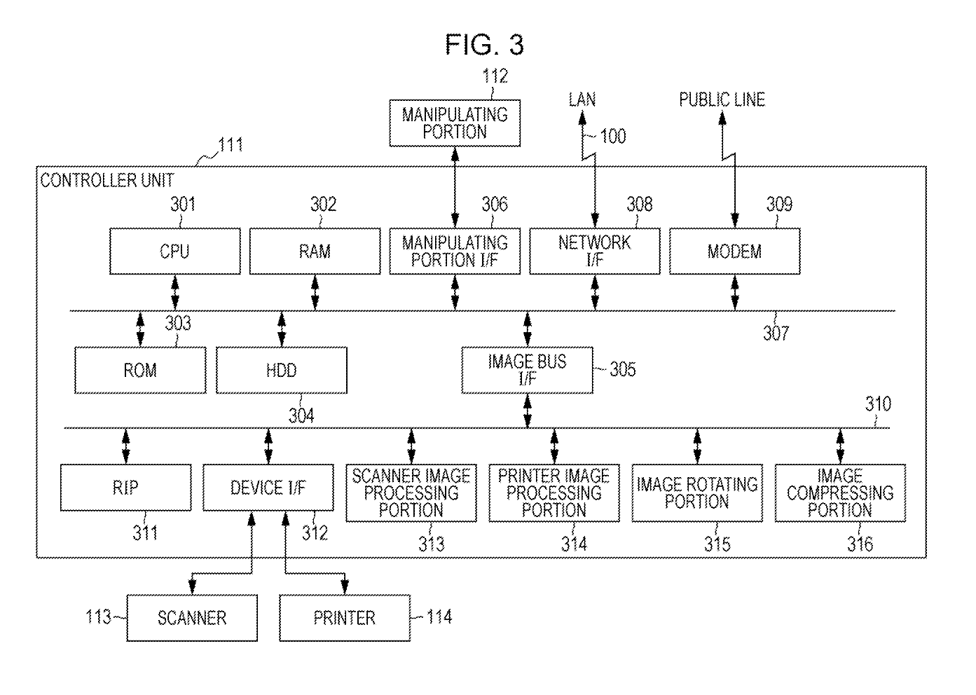

FIG. 3 is a block diagram illustrating a detailed configuration of the image processing apparatus 110 illustrated in FIG. 1.

Referring to FIG. 3, the controller unit 111 controls the entirety of the apparatus. The controller unit 111 is connected to the scanner 113, i.e., the image input device, and the printer 114, i.e., the image output device, in order to control them. Further, the controller unit 111 is connected to the LAN 100 and a public line to receive and output image information and device information from and to an external device through the LAN 100 and the public line. Examples of the external device connected to the public line include a facsimile machine and an information processing apparatus with the facsimile function.

The controller unit 111 is connected to the following devices via a system bus 307. In this embodiment, the devices include a CPU 301, a RAM 302, a ROM 303, a HDD (Hard Disk Drive) 304, an image bus I/F 305, a manipulating portion I/F 306, a network I/F 308, and a modem (MODEM) 309.

The RAM 302 is a memory providing a working area for the CPU 301. The RAM 302 is also used as an image memory for temporarily storing image data. The ROM 303 is a boot ROM and stores a boot program for the system. The HDD 304 stores system software, image data, etc.

The manipulating portion I/F 306 is an interface for executing inputting and outputting with respect to the manipulating portion 112. Image data to be displayed on the manipulating portion 112 is output to the manipulating portion 112 via the manipulating portion I/F 306. Also, the manipulating portion I/F 306 serves to transfer, to the CPU 301, information that has been input by the user through the manipulating portion 112.

The network I/F 308 is connected to the LAN 100 to input and output information with respect to the LAN 100. The MODEM 309 is connected to the public line to input and output information with respect to the public line. The image bus I/F 305 serves as a bus bridge for connecting the system bus 307 and an image bus 310, which transfers image data at a high rate, to each other for conversion of a data structure.

The image bus 310 is connected to an RIP (Raster Image Processor) 311, a device I/F 312, a scanner image processing portion 313, a printer image processing portion 314, an image rotating portion 315, and an image compressing portion 316.

The RIP 311 opens up a PDL code, which has been received through the LAN, into a bit map image. The device I/F 312 connects the scanner 113 and the printer 114 to the controller unit 111 for conversion of image data between synchronous and asynchronous systems.

The scanner image processing portion 313 executes corrections, processing, editing, etc. on the input image data. The printer image processing portion 314 executes printer corrections, conversion of resolution, etc. on the print output image data. The image rotating portion 315 rotates the image data.

The image compressing portion 316 executes a compression/decompression process for multi-valued image data in accordance with JPEG. The image compressing portion 316 also executes a compression/decompression process for binary image data in accordance with, e.g., JBIG, MMR, or MH.

### [External Configuration of Image Processing Apparatus 110]

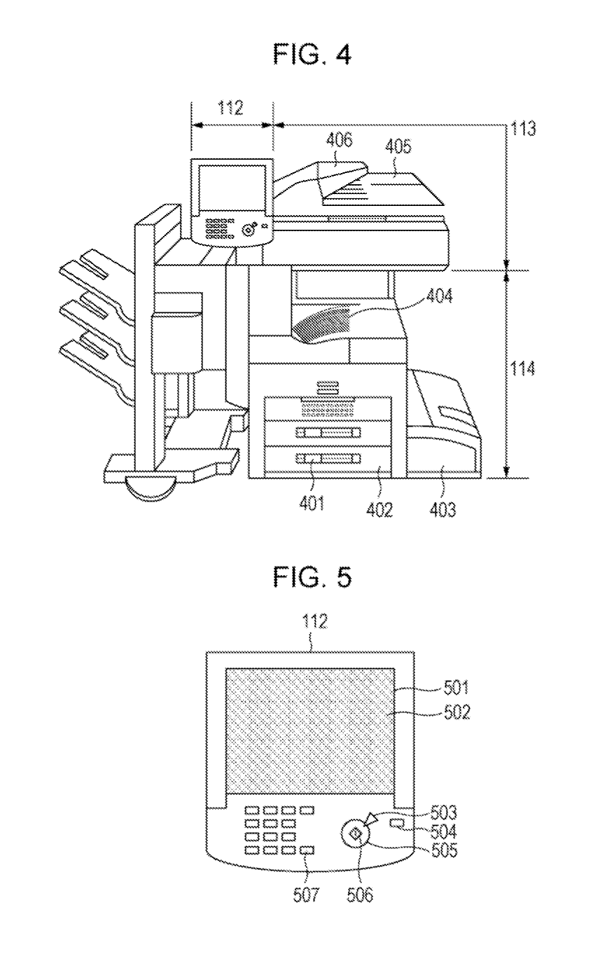

An external configuration of the image processing apparatus 110 will be described below with reference to FIG. 4.

FIG. 4 is an external view of the image processing apparatus 100 illustrated in FIG. 1.

Referring to FIG. 4, in the image processing apparatus 110, the scanner 113 generates raster image data by illuminating an image on each sheet of an original document and scanning a CCD line sensor (not shown). When a user sets sheets of the original documents in a tray 406 of a document feeder 405 and instructs start of read on the manipulating portion 112, the CPU 301 of the controller unit 111 issues an instruction to the scanner 113. The document feeder 405 feeds the sheets of the original documents one by one, and the scanner 113 executes an operation of reading an image on each original document fed from the document feeder 405.

The printer 114 prints the raster image data on a sheet supplied from one of sheet cassettes 401, 402 and 403 and outputs the printed sheet onto a paper output tray 404. A printing method used in the printer 114 can be an electrophotography using a photosensitive drum or a photosensitive belt.

### [External Layout of Manipulating Portion 112 of Image Processing Apparatus 110]

An external layout of the manipulating portion 112 will be described below with reference to FIG. 5.

FIG. 5 is an external layout view of the manipulating portion 112 illustrated in FIG. 1.

Referring to FIG. 5, the manipulating portion 112 includes an LCD display portion 501 that is constituted by bonding a touch panel 502 onto an LCD.

In the LCD display portion 501, there are displayed a system operating screen and soft (software) keys. When one of the displayed keys is pressed, position information indicating the pressed position is transmitted to the CPU 301. Further, the manipulating portion 112 includes various hard (hardware) keys, such as a start key 505, a stop key 503, an ID key 507, and a reset key 504.

The start key 505 is a key for instructing the start of the operation of reading an image on the original document. An LED display portion 506 capable of displaying two colors of green and red is disposed at a center of the start key 505. The two-color LED display portion 506 represents, depending on each of the two colors, whether the start key 505 is in a usable state or not. The stop key 503 is a key used to stop the operation during execution. The ID key 507 is a key used when the user inputs a user ID. The reset key 504 is a key used when the setting having been input from the manipulating portion 112 is initialized.

### [Configuration of Manipulating Portion 112 of Image Processing Apparatus 110]

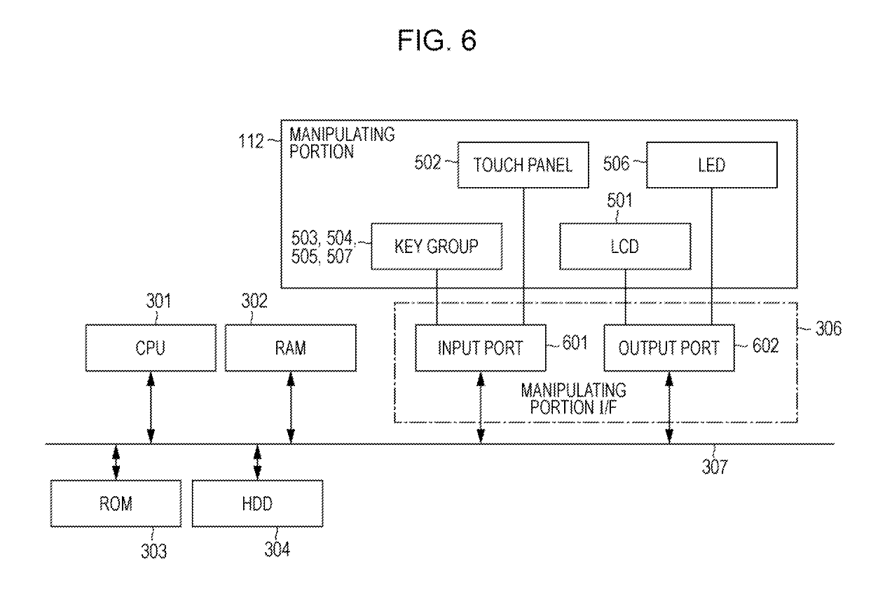

A configuration of the manipulating portion 112 will be described below with reference to FIG. 6.

FIG. 6 is a block diagram illustrating a detailed configuration of the manipulating portion 112 in FIG. 1.

Referring to FIG. 6, the manipulating portion 112 is connected to the system bus 307 via the manipulating portion I/F 306. As described above, the CPU 301, the RAM 302, the ROM 303, the HDD 304, etc. are connected to the system bus 307. The manipulating portion I/F 306 includes an input port 601 for controlling an input by the user and an output port 602 for controlling a screen output device. The input port 601 transfers, to the CPU 301, user inputs from the touch panel 502 and a key group including the various keys 503, 504, 505, and 507. In accordance with the substance of each user input and a control program, the CPU 301 generates display screen data and outputs the display screen data to the LCD display portion 501 via the output port 602. Further, the CPU 301 controls, as required, the LED display portion 506 via the output port 602.

### [Configuration of Web Browser 209 in Image Processing Apparatus 110]

The Web Browser 209, illustrated in FIG. 2, establishes connection with another network node via the HTTP module 214 and executes communication. In the communication, an HTTP request is issued to the resource described in terms of URL, and a response to the HTTP request is obtained. In such a process, encoding/decoding of communication data is also executed in accordance with various coding modes.

An event processing portion (not shown) receives events indicating manipulations that are performed by the user upon a sheet of the touch panel 502, the various keys, etc. in the manipulating portion 112, and executes processing that corresponds to each of the received events. In addition, the event processing portion receives state transition events in the apparatus, jobs, etc. from the Control API 218, and executes processing that corresponds to each of the received events. A script interpreter (not shown) is an interpreter for interpreting and executing a script, such as Java (registered trademark) Script (ECMA Script). The script is embedded in a document, or it is described in another file linked with a document. By using scripts, a contents provider can program dynamic behaviors of the document to be provided.

[Flow of Request and Response in Accordance with HTTP Protocol]

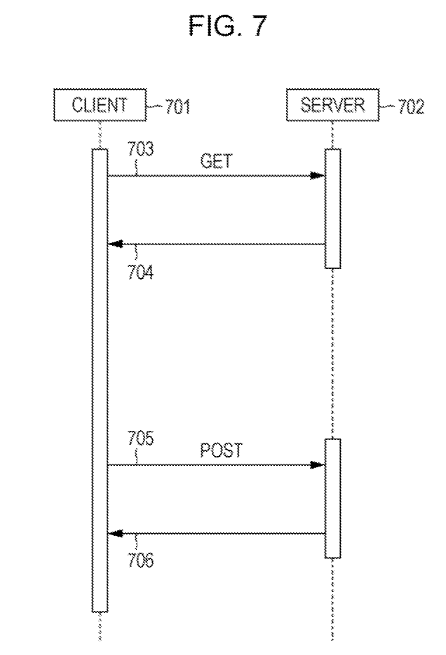

FIG. 7 is a chart illustrating flow of processing of a request and a response in accordance with the HTTP protocol, which is executed by the HTTP module 214 illustrated in FIG. 2.

Referring to FIG. 7, a client 701 represents an apparatus in which software for transmitting an HTTP request and receiving an HTTP response, as illustrated in FIG. 7, is installed. In this embodiment, the client 701 corresponds to the image processing apparatus 110 in which the Web Browser 209 is installed or the host computer 120 in which a web browser is installed.

A server 702 represents software for receiving the HTTP request, executing processing that corresponds to the received HTTP request, and replying the HTTP response. In this embodiment, the server 701 corresponds to the server 130 illustrated in FIG. 1.

The client 701 can transmit the HTTP request in accordance with one of the GET method and the POST method. When the client 701 transmits, to the server 702, an HTTP request 703 for the desired resource in accordance with the GET method, the resource is generally designated in the URI (particularly URL) format. The server 702 obtains or generates data corresponding to the resource that is designated by the HTTP request 703, and replies the data as an HTTP response 704.

The case of transmitting the HTTP request in accordance with the POST method is now described.

When an HTML document includes a “form” and a transmission method put in the form designates the POST method, the following process is executed.

Information input by the user is encoded to the form that is displayed by the web browser in the client 701. Further, the client 701 transmits the encoded information, i.e., the input details of the form, to the server 702 as an attachment to an HTTP request 705.

In the server 702, the designated resource receives and processes the data transmitted from the client 701, generates an HTTP response 706, and replies the HTTP response 706 to the client 701.

### [Browser Screen Layout in Image Processing Apparatus 110]

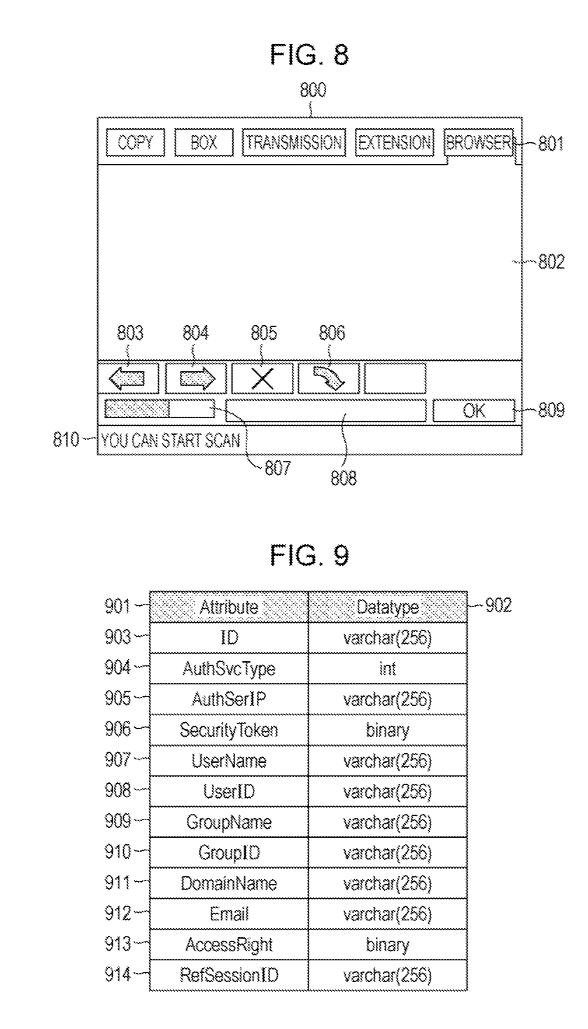

A browser screen layout of the web browser displayed by the UI module 201 will be described below with reference to FIG. 8. A process of receiving a processing request from the user is described by using a web browser screen obtained from the server 130.

FIG. 8 illustrates one example of a user interface (UI) displayed on the LCD display portion 501 illustrated in FIG. 6. This example corresponds to a web browser screen displayed by the UI module 201.

Referring to FIG. 8, a browser screen 800 displays thereon a URL input field 808, a content display area 802, and a status area 807. The browser screen 800 further displays thereon various buttons, such as a tab 801, an OK button 809, a progress bar, a return button 803, an advance button 804, a reload button 806, and a stop button 805. Be it noted that the forms and the positions in and at which the buttons are displayed are not limited to those indicated on the display screen illustrated in this example.

The tab 801 functions as a button for changing a screen between the web browser function and one of other functions (i.e., copy, box, transmission, and extension). The URL input field 808 is a field in which the user inputs the URL of the desired resource. When the user presses the URL input field 808, a virtual full keyboard (not shown) for inputting characters is displayed. The user can input a string of desired characters by touching soft keys that are arranged on the virtual full keyboard in imitation of hardware key tops.

The OK button 809 is a soft key used when the user definitively confirms a character string of URL that has been input. When the URL is definitively confirmed by pressing of the OK button 809, the Web Browser 209 issues an HTTP request for obtaining the relevant resource.

The progress bar indicates the status of progress in the content obtaining process based on the HTTP request and response. The content display area 802 is an area in which the obtained resource is displayed. The return button 803 is a soft key used to display again the content having been displayed prior to the content, which is currently displayed, while going back the history of content display.

The advance button 804 is a soft key used to advance to the content having been displayed after the content, which is currently displayed, when the contents are displayed while going back the history of content display.

The reload button 806 is a soft key used to re-obtain and re-display the content that is currently displayed. The stop button 805 is a soft key used to stop the content obtaining process during execution.

A status area 810 is an area for displaying messages issued based on the various functions of the image processing apparatus. The status area 810 can display the message for calling the user's attention based on each of the scanner, printer, or other functions even when the browser screen 800 is being displayed.

In addition, a message can be similarly displayed based on the web browser function. The web browser function displays a character string of URL of the linked web, a character string of the content title, a message instructed by the script, and so on.

### [Authentication Context Management (ACM) Module]

The ACM 206, illustrated in FIG. 2, manages authentication contexts received from the authentication service modules described below. The authentication service includes the LAS 210, the RAS 211, and the WAS 212. If the authentication has succeeded, each of the LAS 210, the RAS 211, and the WAS 212 transfers information necessary as an authentication context to the ACM 206. The ACM 206 prepares an authentication context and writes the user information therein. After the authentication has succeeded and the user information has been written in the authentication context, subsequent user manipulations are all actuated in right of the user whose name is written in the authentication context.

Further, the ACM 206 manages the authentication context. The period during which the ACM 206 manages the authentication context is, as described above, a period from the time when the authentication context has been prepared after the success of the user authentication to the time when the user makes the log-out process.

Log-out conditions are provided, for example, by the log-out process made by the user, by no operations executed during a set time-out time, by a change in any of various items of device setting information, by a shift to a low-power mode, restart of the device, etc.

A data structure of the authentication context will be described below with reference to FIG. 9. FIG. 9 illustrates the data structure of the authentication context that is prepared and managed by the ACM 206 illustrated in FIG. 2.

Referring to FIG. 9, an attribute (“Attribute”) column 901 represents the attribute of the authentication context. A data type (“DataType”) column 902 represents the data type corresponding to each attribute.

An authentication service type attribute (AuthSvcType) 904 stores information for distinguishing by which one of the authentication services (i.e., the LAS 210, the RAS 211, and the WAS 212) the authentication context has been prepared.

An authentication server address attribute (AuthSerIP) 905 stores the IP address of the authentication server 140. An ST attribute (SecurityToken) 906 stores the ST obtained from the authentication server 140.

A user name attribute (UserName) 907 stores the user name obtained from the authentication server 140. A user ID attribute (UserID) 908 stores the user ID obtained from the authentication server 140.

A group name attribute (GroupName) 909 stores the group name to which the user obtained from the authentication server 140 belongs. A group ID attribute (GroupID) 910 stores the group ID of the group obtained from the authentication server 140.

A domain name attribute (DomainName) 911 stores the domain name to which the user obtained from the authentication server 140 belongs. A mail address attribute (Email) 912 stores the mail address of the user obtained from the authentication server 140.

The right attribute (AccessRight) 913 stores information indicating whether the user obtained from the authentication server 140 has the right for operations, e.g., a copy operation and a scan operation. A session ID reference attribute (RefSessionID) 914 stores information of reference to the session resource that has been prepared by using the authentication context as a key.

### [Flow of Processing for WAS 212]

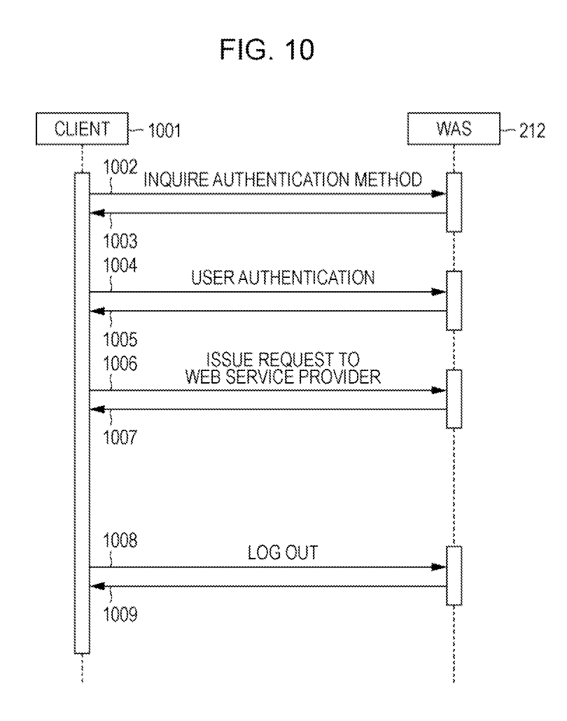

FIG. 10 is a chart illustrating one example of processing for the WAS 212 illustrated in FIG. 2. In FIG. 10, S1002 to S1009 represent successive steps.

Referring to FIG. 10, a client 1001 is a terminal, which installs therein software for transmitting, as web service, an HTTP request to the WAS 212 and for receiving an HTTP response. In this embodiment, the client 1001 corresponds to the server 130.

First, in S1002, the client 1001 transmits, to the WAS 212 in the image processing apparatus 110, an HTTP request to inquire about the authentication method. Then, in S1003, the WAS 212 replies, in response to the request transmitted from the client 1001 in S1002, the authentication method to the client 1001.

Further, the WAS 212 executes the user authentication for the Credential received from the client 1001. When the user authentication is executed upon the ST being transferred from the client 1001 to the WAS 212, the WAS 212 makes confirmation to the authentication server 140 in S1004 whether the relevant ST is valid. If the ST is valid, “OK” is replied from the authentication server 140.

If the user authentication has succeeded, the WAS 212 requests the ACM 206 to prepare an authentication context. The ACM 206 prepares and stores the authentication context based on both the ST and the user information. After the authentication context has been prepared in such a way, the user can utilize the service of the image processing apparatus 110 via the web service in right based on the authentication context.

In S1005, the WAS 212 replies the ST to the client 1001. Then, in S1006, the client 1001 inserts the ST in a header portion of a web service description in the added form and transmits an HTTP request to the image processing apparatus 110.

The WAS 212 reads the ST in the header portion of the HTTP request that has been received from the client 1001, and determines whether the read ST is valid. If the WAS 212 determines that the received ST is not valid, an error notification is replied in S1007 to the client 1001. If the WAS 212 determines that the received ST is valid, the WAS 212 confirms whether the authentication context prepared via the local authentication service and the authentication context prepared via the web service are matched with each other.

If the WAS 212 determines that the above-mentioned two authentication contexts are matched with each other, the WAS 212 calls the web service from the WSP 207. On the other hand, if the WAS 212 determines that the above-mentioned two authentication contexts are not matched with each other, the WAS 212 replies an error notification to the client 1001 in S1007.

In S1008, the client 1001 transmits an HTTP request for log-out to the WAS 212. Upon receiving the log-out request, the WAS 212 requests the ACM 206 to discard the corresponding authentication context. Responsively, the ACM 206 discards the authentication context.

In S1009, the WAS 212 replies “OK” to the client 1001 if the authentication context is discarded successfully, and replies “NO” if the discarding of the authentication context has failed.

### [Detailed Configuration of Server 130]

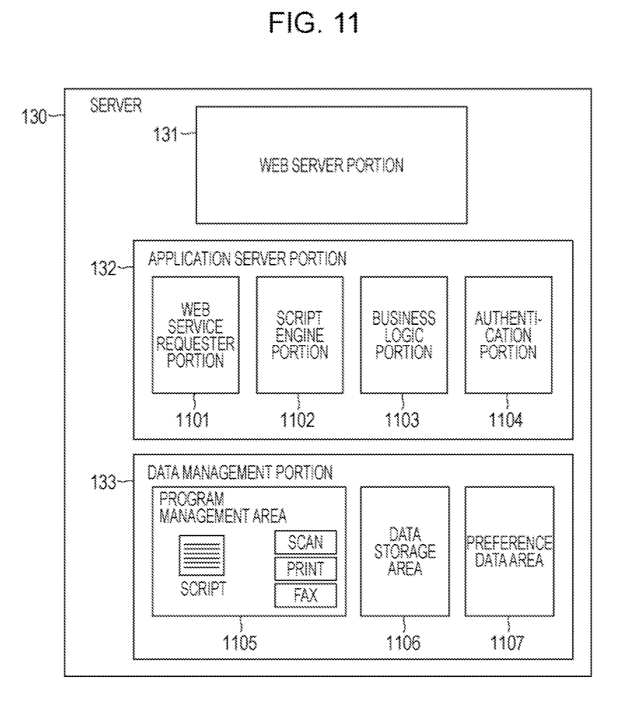

FIG. 11 is a block diagram illustrating a detailed configuration of the server 130 illustrated in FIG. 1.

Referring to FIG. 11, a business logic portion 1103 in an application server portion 132 is called by the web server portion 131 in response to the HTTP request and executes processing. The business logic portion 1103 replies an HTML document, which has been dynamically produced, as a processing result to the web server portion 131.

A script engine portion 1102 in the application server portion 132 is called by the business logic portion 1103 and, after reading a script from a program management area 1105 (described later), it replies the script to the business logic portion 1103. Herein, the term “script” represents a program execution description.

The business logic portion 1103 successively executes the scripts read by the script engine portion 1102. A web service requester portion 1101 is called by the business logic portion 1103 to execute call of web service for an external web service provider (e.g., the WSP 207).

An authentication portion 1104 is called by the business logic portion 1103 to execute management and control of the user authentication process, management of the user information, and management of the user setting. The program management area 1105 manages various scripts and programs called by the scripts. Data in the program management area 1105 can be added or altered by using a plug-in mechanism (not shown). The plug-in mechanism enables the function of the server 130 to be customized. A data storage area 1106 is an area for storing data, such as documents. A preference data storage area 1107 is an area for storing setting information per user.

The business logic portion 1103 obtains setting information per user, which is stored in the preference data area 1107, by using, as an access key, the ST obtained from the authentication portion 1104. Further, the business logic portion 1103 provides a screen and a function, which are customized per user, by using the obtained setting information per user.

With the system configuration described above, the user operating the image processing apparatus 110 obtains the user interface installed in the server 130 and causes the obtained user interface to be displayed on the manipulating portion 112 of the image processing apparatus 110. Then, the user inputs an instruction that causes the image processing apparatus 110 to execute the desired processing by using the user interface that is displayed on the manipulating portion 112. The instruction input by the user is transmitted to the server 130 from the image processing apparatus 110. The server 130 determines the substance of the processing instructed by the user and transmits a processing request corresponding to the substance of the instruction to the image processing apparatus 110. The image processing apparatus 110 receives the processing request transmitted from the server 130 and operates in accordance with the received processing request. In such a way, the user can cause the image processing apparatus 110 to execute the desired operation by using the interface installed in the server 130. The processing request may be transmitted in the session that has been started upon the server 130 transmitting the user interface, or may be started in a different session that is started separately from the above-described session.

The processing request includes information for specifying the image processing apparatus 110 such that the image processing apparatus 110 can execute the desired process.

Alternatively, the user may cause the image processing apparatus 110 to operate as follows. For example, the user may instruct control to be executed such that the processing request is transmitted to an external apparatus other than the server 130 by using the user interface which is installed in the server 130, and that the external apparatus transmits the result of the processing request to the image processing apparatus 110. The processing request transmitted to the external apparatus is, e.g., a request for downloading data. In such a case, after the external apparatus has downloaded data from the place designated by the user and the downloading has been completed, the downloaded data is transmitted to the image processing apparatus 110.

### [Details of Session-Manager Module (MS) 204]

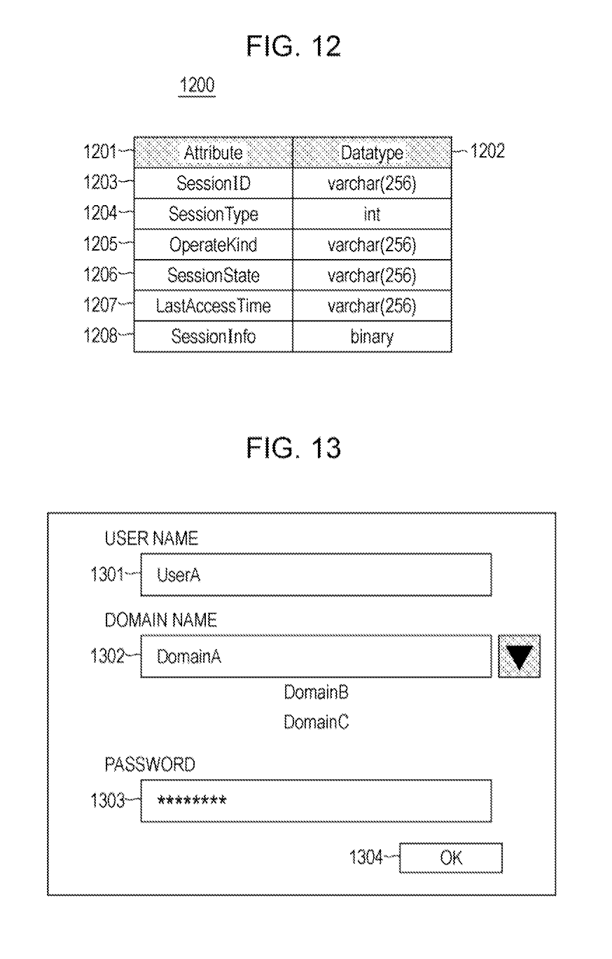

FIG. 12 illustrates a data structure of a session 1200 that is managed by the Session-Manager module (MS) 204 illustrated in FIG. 2. Referring to FIG. 12, an attribute (“Attribute”) column 1201 represents the attribute fixedly set for each session. A data type (“DataType”) column 1202 represents the data type corresponding to each attribute.

A session ID attribute (SessionID) 1203 is the identification number for uniquely identifying each session. A session type attribute (SessionType) 1204 stores information for distinguishing via which one of the authentication services (i.e., the LAS 210, the RAS 211, and the WAS 212) the session has been prepared. In this embodiment, when the session has been prepared via the LAS 210, a flag is set at the first bit. In addition, when the session has been prepared via the RAS 211, a flag is set at the second bit.

Further, when the session has been prepared via the WAS 212, a flag is set at the third bit. For example, when the session resource has been reserved via the LAS 210 and the session has been referred to via the web authentication service (WAS), a flag is set at each of the first bit and the third bit. The flag serves as information utilized when the resource is released. Upon the flag value being reset to zero (0), the resource is released.

An operation kind attribute (OperateKind) 1205 stores information for distinguishing the kind of operation for which the session resource has been reserved, i.e., what kind of operation is intended by the reserved session resource. The kind of operation includes, for example, the print operation, the scan operation, the fax operation, the operation of uploading the device setting information, the operation of downloading the device setting information, the operation of obtaining the device state, etc.

The session state attribute (SessionState) 1206 stores information for distinguishing the session state. The session can take a “resource reserved state”, a “processing wait state”, or a “state during execution of processing”. The “resource reserved state” represents a state taken when a vacant session resource is reserved by using the authentication context as a key. The “state during execution of processing” represents a state immediately before the externally applied processing request is executed. The “processing wait state” represents a state after the processing has ended.

A last access time attribute (LastAccessTime) 1207 stores a time at which reference, write or read has been last made on the session.

A program as required freely utilizes a session information attribute (SessionInfo) 1208. In other words, a program generates as a dynamic attribute the session information attribute (SessionInfo) 1208. A dynamic attribute value can be freely called in accordance with the program by using both the session ID attribute 1203 and a dynamic attribute key set by the user.

The SM 204 executes session priority management by using a session 1200. Regarding the session states stored in the session state attribute 1206, priority is set in the descending order of (1) the “state during execution of processing”>(2) “resource reserved state”>(3) the “processing wait state”.

Further, for each session state, priority is determined for the kinds of operations stored in the operation kind attribute 1205. More specifically, the priority is set in the descending order of (1) the print operation, the scan operation, and the fax operation>(2) the operation of uploading the device setting information and the operation of downloading the device setting information>(3) the operation of obtaining the device state>(4) etc. Moreover, per kind of operation, the operation for which the last access time stores in the last access time attribute 1207 is closer to the current time has higher priority. The Session-Manager module 204 is called via the LAS 210 or the RAS 212 to execute management and control in reserving or releasing the session resource.

Further, the Session-Manager module 204 executes management and control in reading or writing the session information. In addition, the Session-Manager module 204 holds therein a session counter for managing the number of sessions, and it manages and controls an upper limit in the number of sessions that can be reserved in the image processing apparatus 110. When communication is performed with respect to an external apparatus, the Session-Manager module 204 reserves a session to start the communication. The Session-Manager module 204 manages each session by storing the session information in a memory, such as the RAM 302. Also, there is set an upper limit in the number of sessions that can be reserved in the Session-Manager module 204. One reason is that, if the sessions are infinitely reserved, a memory having a large capacity is required to reserve the session information. Another reason is that, if the sessions are infinitely reserved, a processing load is increased too much because of the necessity of communicating with many external apparatuses at the same time by using the reserved sessions.

### [First Flow According to First Embodiment]

FIG. 13 illustrates one example of a log-in screen displayed on the manipulating portion 12 of the image processing apparatus 110 illustrated in FIG. 1. In the illustrated example, the user logs in to the image processing apparatus 110 by inputting a Credential made up of a user name, a domain name, and a password. After having logged in to the image processing apparatus 110, the user is allowed to use the image processing apparatus 110. While this embodiment is described in connection with the case where the authentication server 140 is constituted by an information processing apparatus independent as an image processing system, the image processing apparatus 110 or the server 130 may have a similar function to that of the authentication server 140.

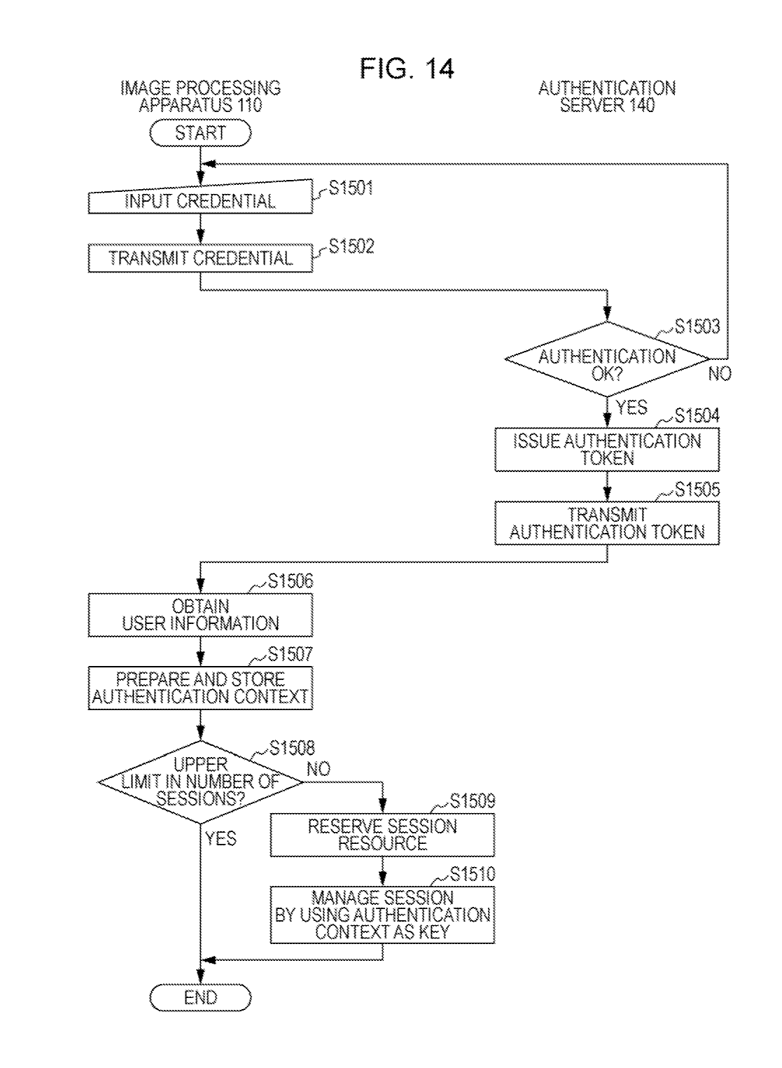

FIG. 14 is a flowchart illustrating one example of data processing procedures in the image processing system according to the first embodiment. The illustrated example represents data processing executed between the image processing apparatus 110 and the authentication server 140 when the user authentication process is executed by using the authentication server 140. In FIG. 14, S1501, S1502, and S1506 to S1510 are realized with the CPU 301 of the image processing apparatus 110 by loading the relevant modules in the RAM 302 and executing them. In addition, S1503 to S1505 are realized with the CPU of the authentication server 140 by loading the relevant modules in the RAM and executing them.

In S1501, the user inputs the user name, the domain name, and the password by employing the user interface, illustrated in FIG. 13, which is displayed on the manipulating portion 112.

In FIG. 13, a text box 1301 is a text box area in which the user name is input. If the user selects the text box 1301, the UI module 201 executed by the CPU 301 displays a soft keyboard on the manipulating portion 112. The user can input characters of the user name by employing the soft keyboard.

A text box 1302 is a text box area in which the domain name is input. The text box 1302 is selectable in the form of a pull-down menu. The number of domains displayed in the pull-down menu corresponds to the number of authentication servers, including 140, which are adaptable with the image processing apparatus 110.

Stated another way, the image processing apparatus 110 can transfer data with respect to a plurality of authentication servers. A text box 1303 is a text box area in which the password is input. When the user presses an OK button 1304 after inputting the above-described items of information, the Credential including the user name, the domain name, and the password is transferred from the UI module 201 to the LAS 210. Then, in S1502, the LAS 210 transmits the Credential to the authentication server 140 via the LAN 100.

In S1503, the authentication server 140 executes the user authentication by using the Credential received from the LAS 210. If the authentication server 140 determines that the user authentication has succeeded, the processing shifts to S1504. If otherwise, the processing returns to S1501. In the latter case, because the Credential received from the LAS 210 is not correct, the authentication server 140 replies a notice indicating a failure of the authentication to the LAS 210, and the authentication screen is displayed on the manipulating portion 112 again. The processing then returns to S1501.

In S1504, the authentication server 140 issues the ST corresponding to the Credential. In S1505, the authentication server 140 replies the issued ST to the LAS 210. On the side of the image processing apparatus 110, in S1506, the LAS 210 makes an inquiry to the authentication server 140 again by using, as a key, the ST received from the authentication server 140, and obtains the user information.

In S1507, the ACM 206 prepares an authentication context and stores it in the RAM 302. In S1508, the SM 204 determines whether the session counter managing the number of session resources reaches an upper limit value (i.e., whether it is equal to or greater than a predetermined value or it exceeds the upper limit value). If the SM 204 determines that the session counter does not reach the upper limit value, the processing shifts to S1509. If the SM 204 determines that the session counter reaches the upper limit value, the processing is brought to an end. When the SM 204 determines in S1508 that the session counter reaches the upper limit value, the fact that the session counter reaches the upper limit value may be notified to the user.

In S1509, the SM 204 reserves a session resource. In S1510, the SM 204 stores a value of a session ID attribute 1203 of the reserved session 1200 as a value of the session ID reference attribute 914 in the authentication context that has been prepared in S1507. This enables using the authentication context as a key to access the session 1200. Further, the SM 204 stores the “resource reserved state” in the session state attribute 1206 of the session 1200. In addition, the SM 204 sets a flag at the first bit of the session type attribute 1204 of the session 1200.

### [Second Flow According to First Embodiment]

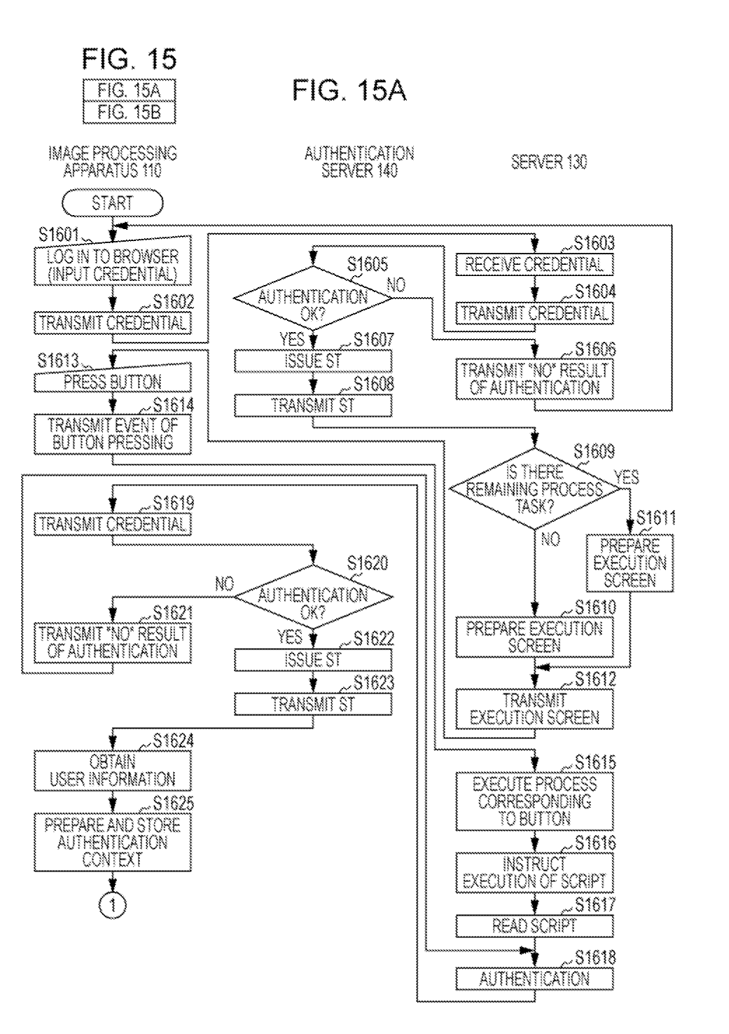

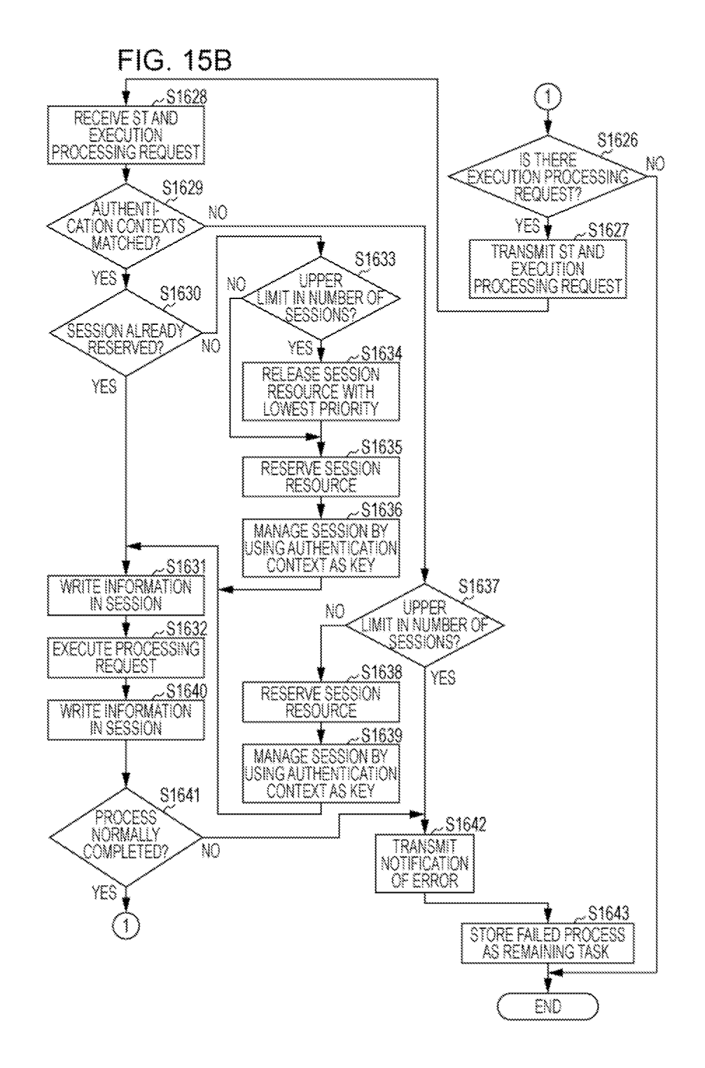

A second flow succeeding to the first flow will be described below with reference to a flowchart illustrated in FIG. 15. The above-described first flow represents the processing executed when the user logs in to the image processing apparatus 110, and the second flow described below represents the processing executed when the user starts up the browser screen 800 in the image processing apparatus 110 to execute a process of communicating with the server 130.

FIGS. 15A and 15B are each a flowchart illustrating one example of data processing procedures in the image processing system according to the embodiment. The illustrated example represents data processing executed among the image processing apparatus 110, the authentication server 140, and the server 130 in the case where using the authentication server 140 executes the user authentication process. In FIGS. 15A and 15B, steps are realized with the CPUs of the image processing apparatus 110, the authentication server 140, and the server 130 by executing the programs stored in their ROMs.

In this processing, when the user performs the user authentication through the manipulating portion 112 and selects the browser screen 800, the Web-Browser module 209 transmits an HTTP request with the PUT method to the URL of the server 130 based on the initially displayed URL information that is managed by the UPM 208. The server 130 operates on the premise of the user authentication. Therefore, if the ST is not included in the HTTP request, the server 130 determines that the user authentication is not yet executed with respect to the client having issued the HTTP request, followed by redirection to the log-in screen.

Accordingly, an HTTP response corresponding to the log-in screen is replied from the server 130 to the Web-Browser module 209 in the image processing apparatus 110, and the log-in screen for logging in to the server 130 is displayed on the browser screen 800.

Meanwhile, when the server 130 is adapted for SSO (Single Sign-On), the Authentication-Context-Management (ACM) module 206 of the image processing apparatus 110 already holds the ST of the authentication server 140. Therefore, the following S1601 to S1608 can be omitted by transmitting the HTTP request, which includes the ST, to the server 130. When S1601 to S1608 are omitted, the processing skips to S1609 from S1601. Processing subsequent to S1601 will be described below.

First, in S1601, an input of the Credential including the user name, the domain name, and the password by the user operating the manipulating portion 112 is accepted on the browser log-in screen (not shown), which is displayed on the manipulating portion 112 of the image processing apparatus 110. The processing then advances to S1602.

In S1602, the Web-Browser module 209 in the image processing apparatus 110 transmits, as an HTTP request with the PUT method, the Credential to the server 130 via the HTTP module 214.

In S1603, the web server portion 131 in the server 130 receives, as the HTTP request, the Credential from the image processing apparatus 110. In S1604, the authentication portion 1104 in the server 130 receives the Credential from the web server portion 131 via the business logic portion 1103 and transmits the Credential to the authentication server 140.

In S1605, the authentication server 140 executes the user authentication by using both the Credential that has been registered per user in advance and the Credential that has been received from the authentication portion 1104 in the server 130. If the authentication server 140 determines that the user authentication has succeeded, the processing shifts to S1607. If the authentication server 140 determines that the Credential received from the authentication portion 1104 in the server 130 is not correct, the processing shifts to S1606. In the latter case, i.e., if the authentication server 140 replies the fact that the Credential received from the authentication portion 1104 in the server 130 is not correct, the web server portion 131 in the server 130 executes control in S1606 as follows. The web server portion 131 prepares an HTML document in which a message indicating a failure of the authentication and the authentication screen are combined with each other, and replies, as an HTTP response, the HTML document to the image processing apparatus 110.

On the other hand, if it is determined that the user authentication has succeeded, the authentication server 140 issues, in S1607, the ST (Security Token) corresponding to the relevant Credential. In S1608, the authentication server 140 replies the ST to the authentication portion 1104 in the server 130.

Further, the authentication portion 1104 in the server 130 makes an inquiry to the authentication server 140 again by using the received ST and obtains the user information. The authentication portion 1104 in the server 130 stores the ST and the user information, both obtained from the authentication server 140, in the preference data area 1107.

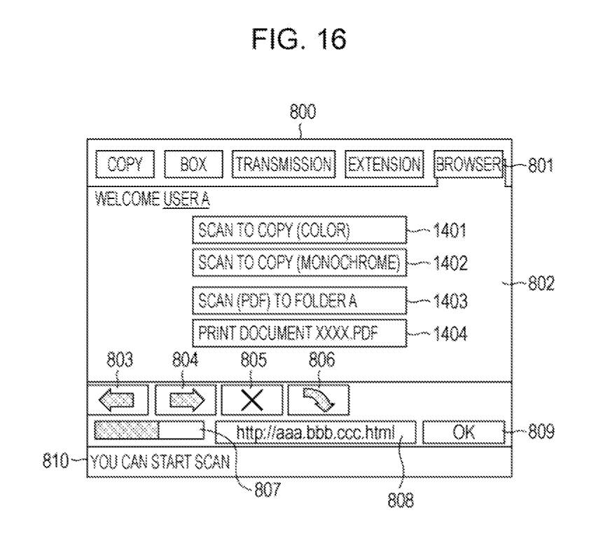

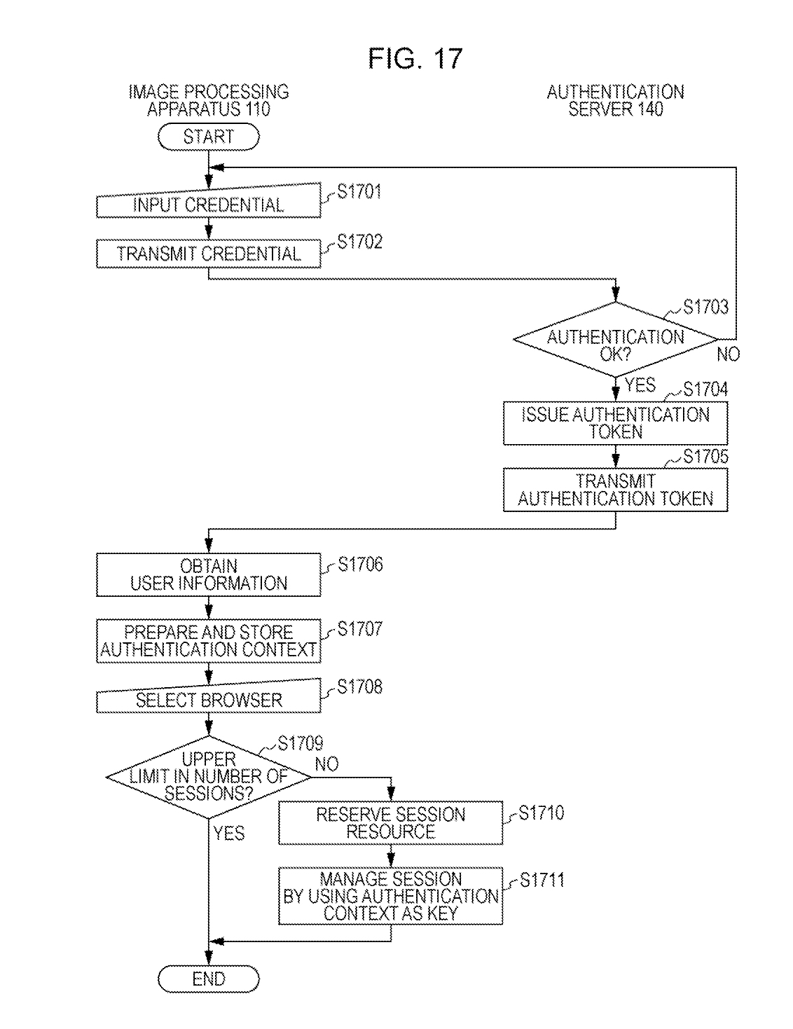

If the user authentication has succeeded, the business logic portion 1103 in the server 130 takes out the user information necessary to prepare a user screen from the preference data area 1107 in the data management area 133 by using the ST for the user as an access key. Then, in S1609, the business logic portion 1103 determines whether there remains any process task that has failed before. If it is determined in S1609 that there remains no process task that has failed before, the processing shifts to S1610. If it is determined in S1609 that there remains any process task that has failed before, the processing shifts to S1611. The term “remaining process task” means a process task which is stored in S1643 (described later) to be left in the server 130 when execution of the function has failed in spite of any of the buttons 1401 to 1404, illustrated in FIG. 16, being pressed by the user. Data stored in S1643 includes the user information representing the user who has pressed the relevant button, and the “script corresponding to the button”. As a result, it is possible to, when the relevant user logs in next, specify the user from the authentication information and to display the remaining process task(s) to only the relevant user.

In other words, by storing and managing the user information and the “script corresponding to the button” in the server 130, the function corresponding to the button can be executed when the relevant user logs in again. For example, when the function corresponding to a button 1403 illustrated in FIG. 16, i.e., the function corresponding to “Scan to folder A” is to be executed, a process of executing that function may be interrupted during the authentication process after the user has pressed the button 1403. Buttons illustrated in FIG. 16 will be described later. In such a case, information regarding, e.g., a path to a storage set to execute the relevant function, is held. Accordingly, when the user logs in next, the path setting process, etc. are no longer required and a manipulation burden imposed on the user can be reduced.

In S1610, the business logic portion 1103 constructs a screen corresponding to the user based on the user information, thereby preparing execution screen information (i.e., a Web page).

On the other hand, in S1611, the business logic portion 1103 constructs a screen in combination of two screens, i.e., a screen displaying the remaining process task(s) and the screen corresponding to the user based on the user information, thereby preparing execution screen information (i.e., a Web page). The processing then advances to S1612.

In S1612, the web server portion 131 in the server 130 replies, to the image processing apparatus 110, the screen, which has been prepared by the business logic portion 1103, as an HTTP response to the HTTP request transmitted from the image processing apparatus 110 in step S1602.

FIG. 16 illustrates one example of the user interface (UI) displayed on the manipulating portion 112 of the image processing apparatus 110 illustrated in FIG. 1. The illustrated example represents the HTTP response which has been received by the image processing apparatus 110 from the server 130 and which is displayed on the browser screen 800. Be it noted that the same elements as those in FIG. 8 are denoted by the same reference numerals. In addition, buttons described below are buttons that are displayed by the services provided by the server 130 after the user authentication.

Referring to FIG. 16, a button 1401 is used to scan an original document of paper in the image processing apparatus 110 and to execute color printing in the image processing apparatus 110.

A button 1402 is used to scan an original document of paper in the image processing apparatus 110 and to execute monochrome printing in the image processing apparatus 110. A button 1403 is used to scan an original document of paper in the image processing apparatus 110 and to convert scanned image data to data in the PDF format in the image processing apparatus 110. With pressing of the button 1403, the image data converted to the PDF format is further stored in a folder A (logical area) in the data storage area 1106 of the server 130 from the image processing apparatus 110.

A button 1404 is used to print a “document XXX.PDF”, which is stored in the data storage area 1106 of the server 130, in the image processing apparatus 110. The user operating the manipulating portion 112 of the image processing apparatus 110 can press the above-mentioned buttons. When information corresponding to the button pressed on the manipulating portion 112 of the image processing apparatus 110 is notified to the server 130, the business logic portion 1103 in the server 130 starts to operate a logic corresponding to the pressed button.

When the business logic portion 1103 starts to operate the logic corresponding to the pressed button, the web service corresponding to the function of the image processing apparatus 110 is called via the web service requester portion 1101 to execute the processing. Because a business logic corresponding to each button is expressed in the form of a script, function buttons can be provided in various patterns depending on the expressions of scripts. In other words, a function button including a plurality of functions linked with each other also can be displayed. For example, a button in combination of two or more of the buttons 1401 to 1404 can be displayed. The screen illustrated in FIG. 16 also can be displayed on a display portion included in the host computer 120. In such a case, more specifically, when the host computer 120 accesses the server 130, the host computer 120 transmits the information including the user ID, the password, etc., which have been input by the user via the web browser, to the server 130. The server 130 causes the authentication server 140 to execute the authentication based on the transmitted information including the user ID, the password, etc. If the authentication has succeeded, the server 130 transmits the screen, illustrated in FIG. 16, to the web browser in the host computer 120 to be displayed therein. The user can instruct the image processing apparatus 110 by using the buttons 1401 to 1404 on the displayed screen. In such a way, the host computer 120 can also provide instructions to the image processing apparatus 110.

When the user presses any of the above-mentioned buttons on the manipulating portion 112 of the image processing apparatus 110, the business logic portion 1103 in the server 130 starts to operate the logic corresponding to the pressed button.

Further, the web service requester portion 1101 in the server 130, illustrated in FIG. 11, calls the web service corresponding to the function of the image processing apparatus 110 to execute the processing. Because a business logic corresponding to each button is expressed in the form of a script, function buttons can be provided in various patterns depending on the expressions of scripts.

In S1613, display control is executed to display the user interface on the manipulating portion 112 based on the execution screen which has been transmitted from the server 130 in S1612. When any of the buttons displayed in the user on the user interface displayed on the manipulating portion 112 of the image processing apparatus 110, the processing advances to S1614 press FIG. 16.

In S1614, an event of the button pressing on the manipulating portion 112 is notified to the Web-Browser module 209 from the UI module 201 illustrated in FIG. 2. Then, an HTTP request with the PUT method, which implies the button pressing, is transmitted from the Web-Browser module 209 to the server 130 via the HTTP module 214. Stated another way, the substance of the instruction corresponding to the button pressed by the user on the manipulating portion 112 is instructed and transmitted as the event of the button pressing to the server 130.

In S1615, the web server portion 131 in the server 130 receives, from the image processing apparatus 110, the HTTP request implying that the button 1401 has been pressed, and requests the business logic portion 1103 to execute the logic process corresponding to the button 1401.

In S1616, the business logic portion 1103 takes out, from the program management area 1105, the script corresponding to the button in the received HTTP request and requests the script engine portion 1102 to execute processing of the script. In S1617, the script engine portion 1102 reads processing details, setting information, etc. for the image processing apparatus 110 from the details of the script and returns them to the business logic portion 1103.

In S1618, the business logic portion 1103 in the server 130 executes the authentication process on the image processing apparatus 110 in order to utilize the function of the image processing apparatus 110 from the web service requester portion 1101 by using the web service. When the ST held in the server 130 is transmitted, the following S1619 to S1623 can be omitted.

In S1619, the WAS 212 in the image processing apparatus 110 transmits the Credential, which has been received from the server 130, to the authentication server 140. The authentication server 140 executes the user authentication based on the Credential received from the WAS 212. In S1620, the authentication server 140 determines whether the user authentication has succeeded. If the authentication server 140 determines that the user authentication has succeeded, the processing shifts to S1622.

On the other hand, if the authentication server 140 determines in S1620 that the Credential received from the WAS 212 is not correct, the authentication server 140 replies to the WAS 212 a notice indicating a failure of the authentication. The processing then shifts to S1621.

In S1621, the WAS 212 in the image processing apparatus 110 further replies the notice indicating a failure of the authentication to the server 130. When the processing shifts to S1622, the authentication server 140 issues the ST corresponding to the Credential and replies the ST to the WAS 212 in the image processing apparatus 110 in S1623.

In S1624, the WAS 212 in the image processing apparatus 110 makes an inquiry to the authentication server 140 again by using, as a key, the ST received from the authentication server 140, and obtains the user information. In S1625, the ACM 206 prepares and stores an authentication context.

If the authentication has succeeded, the business logic portion 1103 in the server 130 performs the process of executing the script replied from the script engine portion 1102 in sequence.

In S1626, the business logic portion 1103 determines whether there is an execution processing request for the image processing apparatus 110. If the business logic portion 1103 determines that there is an execution processing request, the processing shifts to S1627. On the other hand, if the business logic portion 1103 determines in S1626 that there is no execution processing request, the processing is brought to an end.

In S1627, the server 130 transmits an HTTP request for web service, including both the ST and the execution processing request, to the image processing apparatus 110.

In S1628, the WAS 212 in the image processing apparatus 110 receives both the ST and the execution processing request from the server 130. The WAS 212 then determines whether the received ST is valid. If the WAS 212 then determines that the received ST is not valid, the image processing apparatus 110 replies an error notification to the server 130.

In S1629, the WAS 212 in the image processing apparatus 110 determines whether the authentication context prepared in a not-shown step via the local authentication service and the authentication context prepared in S1625 via the web service are matched with each other. The determination as to whether both the authentication contexts are matched with each other can be made by a method of performing a comparison. The performed comparison may be based on any of the ST attribute 905, the user name attribute 906, the user ID attribute 907, the group name attribute 908, the group ID attribute 909, the domain name attribute 910, and the mail address attribute 911. A also can be method of performing a comparison based on a combination of those attributes also can make the S1629 determination.

If, as a result of comparing the authentication contexts, the WAS 212 determines that both the authentication contexts are not matched with each other, the processing shifts to S1637. If the WAS 212 determines that both the authentication contexts are matched with each other, the processing shifts to S1630. In addition, if the WAS 212 determines that there is no authentication context prepared via the local authentication service, the processing shifts to S1637.

Then, the WAS 212 makes an inquiry to the SM 204 whether a session corresponding to the authentication context prepared via the LAS 210 is reserved. In S1630, the WAS 212 determines whether the SM 204 has already reserved the corresponding session. If the WAS 212 determines that the SM 204 has already reserved the corresponding session, the processing shifts to S1631. If the WAS 212 determines that the SM 204 has not yet reserved the corresponding session, the processing shifts to S1633.

In S1631, the SM 204 sets a flag at the third bit in the session type attribute 1204 of the session 1200 to indicate that the WAS 212 has made the reference. Further, the SM 204 stores, in the operation kind attribute 1205 of the session 1200, information indicating what kind of the execution processing request. Still further, the SM 204 stores the “state during execution of processing” in the session state attribute 1206 of the session 1200.

In S1632, the image processing apparatus 110 executes the processing request, e.g., scan (reading process) or print (printing process). The processing request may be, e.g., a request for printing data stored in the HDD 304 or some other processing request than the above-mentioned examples. The embodiment has been described in connection with the case where the server 130 transmits the user interface and the image processing apparatus 110 transmits, to the server 130, the instruction input by the user through the transmitted user interface. Further, in that case, the server 130 directly receives the transmitted instruction. However, some apparatus other than the server 130 may transfer the instruction transmitted by the instruction transmission to reach the server 130.

If the WAS 212 determines in S1630 that there is no session already reserved, the SM 204 determines in S1633 whether the session counter managing the number of session resources reaches the upper limit value. If the SM 204 determines in S1633 that the session counter does not reach the upper limit value, the processing shifts to S1635. If the SM 204 determines that the session counter reaches the upper limit value, the processing shifts to S1634.

In S1634, the SM 204 releases the session resource with the lowest priority. In S1635, the SM 204 reserves a session resource. In S1636, the SM 204 stores a value of the session ID attribute 1203 of the reserved session 1200 as a value of the session ID reference attribute 914 in the authentication context that the LAS 210 prepared.

Also, the SM 204 stores the value of the session ID attribute 1203 of the reserved session 1200 as a value of the session ID reference attribute 914 in the authentication context that has been prepared by the WAS 212. Further, the SM 204 stores the “resource reserved state” in the session state attribute 1206 of the session 1200.

In addition, the SM 204 sets a flag at each of the first bit and the third bit of the session type attribute 1204 of the session 1200.

On the other hand, if the WAS 212 determines in S1629 that both the authentication contexts are not matched with each other, the SM 204 determines in S1637 whether the session counter managing the number of session resources reaches the upper limit value. If the SM 204 determines that the session counter does not reach the upper limit value, the processing shifts to S1638. If the SM 204 determines that the session counter reaches the upper limit value, the processing shifts to S1642.

In S1638, the SM 204 reserves a session resource. In S1639, the SM 204 stores a value of the session ID attribute 1203 of the reserved session 1200 as a value of the session ID reference attribute 914 in the authentication context prepared by the WAS 212.

Further, the SM 204 stores the “resource reserved state” in the session state attribute 1206 of the session 1200. In addition, the SM 204 sets a flag at the third bit of the session type attribute 1204 of the session 1200.

In S1640, the SM 204 stores the “processing wait state” in the session state attribute 1206 of the session 1200. In S1641, the SM 204 determines whether the process corresponding to S1632 has been normally completed. If the SM 204 determines that the relevant process has been normally completed, the processing shifts to S1626. If the SM 204 determines that the relevant process has not been normally completed, the processing shifts to S1642.

In S1642, the image processing apparatus 110 replies an error notification to the server 130. In S1643, the business logic portion 1103 in the server 130 stores the failed process in the preference data area 1107. The processing is thereby brought to an end.

As described above, this embodiment has a merit that, by installing the user interface in an external apparatus such as the server 130, software can be installed more easily than the case of installing the user interface in the image processing apparatus 110. The reason is as follows. In the case of installing the user interface in the image processing apparatus 110, the user is required to be fully skilled in the programming method specific to the image processing apparatus 110. In contrast, when the user interface is installed in the server 130, the user is just required to be able to install software for the web application.

In addition, as described above, the session resource is previously reserved through the manipulating portion 112 of the image processing apparatus 110 by using the user authentication information as a key when the user authentication is executed. As a result, an external processing request instructed by the user in front of the image processing apparatus 110 can be reliably executed. In practice, for example, it is possible to prevent such a trouble that, after the user has logged in to the image processing apparatus 110, a session cannot be reserved in a stage of receiving, from the external server 130, a processing request corresponding to an instruction that has been input through the manipulating portion 112 of the image processing apparatus 110.

### SECOND EMBODIMENT

A second embodiment will be described below with reference to a flowchart of FIG. 17.

FIG. 17 is a flowchart illustrating one example of data processing procedures in an image processing system according to the second embodiment. The illustrated example represents data processing executed between the image processing apparatus 110 and the authentication server 140 when the authentication server 140 is used to execute the user authentication process. In FIG. 17, S1701, S1702, and S1706 to S1711 are realized with the CPU 301 of the image processing apparatus 110 by loading the relevant modules in the RAM 302 and executing them.

In addition, S1703 to S1705 are realized with the CPU of the authentication server 140 by loading the relevant modules in the RAM and executing them. For convenience of the explanation, various steps are illustrated as a series of steps to describe the processing that is executed in the authentication server 140 in a manner linked with the operation in the image processing apparatus 110.

S1701 to S1707 in FIG. 17 correspond respectively to S1501 to S1507 in FIG. 14. The following description is made only about the difference in comparison with the first embodiment.

If the user authentication has succeeded, the manipulating portion 112 of the image processing apparatus 110 displays, as a default screen, an application select screen (not shown). The user can utilize the desired one of applications, such as copy, fax, and browser, by selecting it. In S1708, the user selects the browser application. S1709 to S1711 correspond respectively to S1508 to S1510.

Thus, the session resource is previously reserved through the manipulating portion 112 of the image processing apparatus 110 by using the user authentication information as a key when the application is selected. As a result, an external processing request instructed by the user in front of the image processing apparatus 110 can be reliably executed.

### THIRD EMBODIMENT

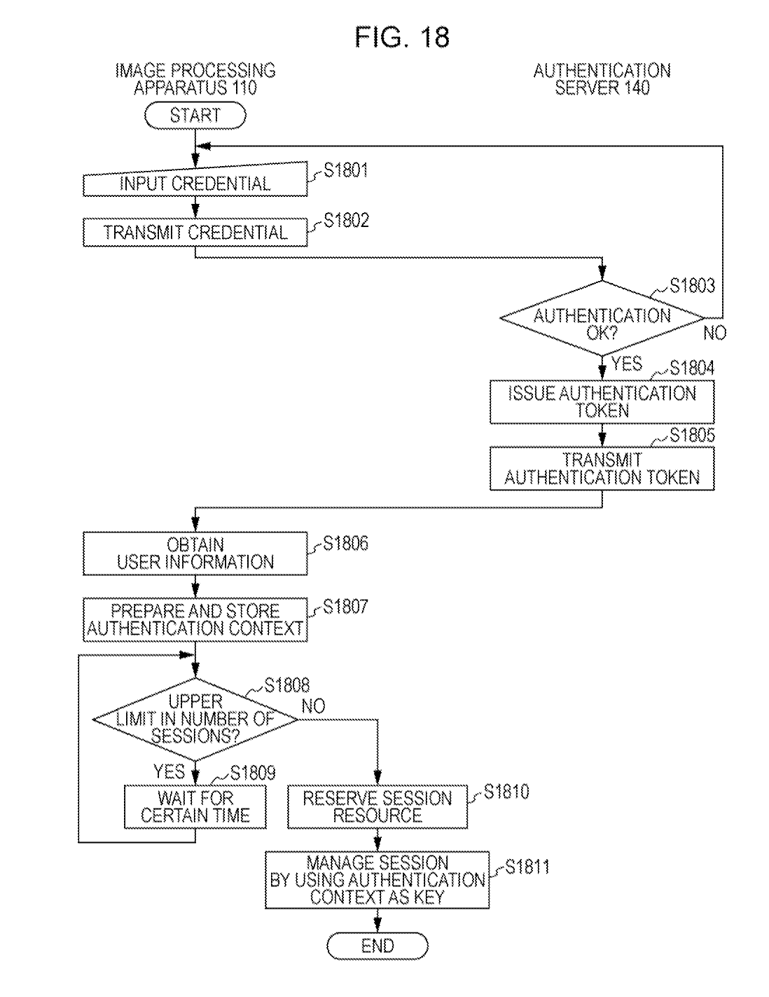

A third embodiment of the present invention will be described below with reference to a flowchart of FIG. 18.

FIG. 18 is a flowchart illustrating one example of data processing procedures in an image processing system according to the third embodiment. The illustrated example represents data processing executed between the image processing apparatus 110 and the authentication server 140 when the user authentication process is executed by using the authentication server 140. In FIG. 18, S1801, S1802, and S1806 to S1811 are realized with the CPU 301 of the image processing apparatus 110 by loading the relevant modules in the RAM 302 and executing them.

In addition, S1803 to S1805 are realized with the CPU of the authentication server 140 by loading the relevant modules in the RAM and executing them. For convenience of the explanation, various steps are illustrated as a series of steps to describe the processing that is executed in the authentication server 140 in a manner linked with the operation in the image processing apparatus 110. The following description is made only about the difference in comparison with the first embodiment.

In S1808, the SM 204 determines whether the session counter managing the number of session resources reaches the upper limit value. If the SM 204 determines that the session counter does not reach the upper limit value, the processing shifts to S1810. If the SM 204 determines that the session counter reaches the upper limit value, the processing shifts to S1809. After the SM 204 waits for a predetermined time in S1809, the processing returns to S1808.

Thus, after the user authentication has been completed through the manipulating portion 112 of the image processing apparatus 110, the upper limit in number of reserved session resources is monitored and, if there is a vacancy in the session resources, the session resource is previously reserved by using the user authentication information as a key. As a result, an external processing request instructed by the user in front of the image processing apparatus 110 can be reliably executed.

### FOURTH EMBODIMENT

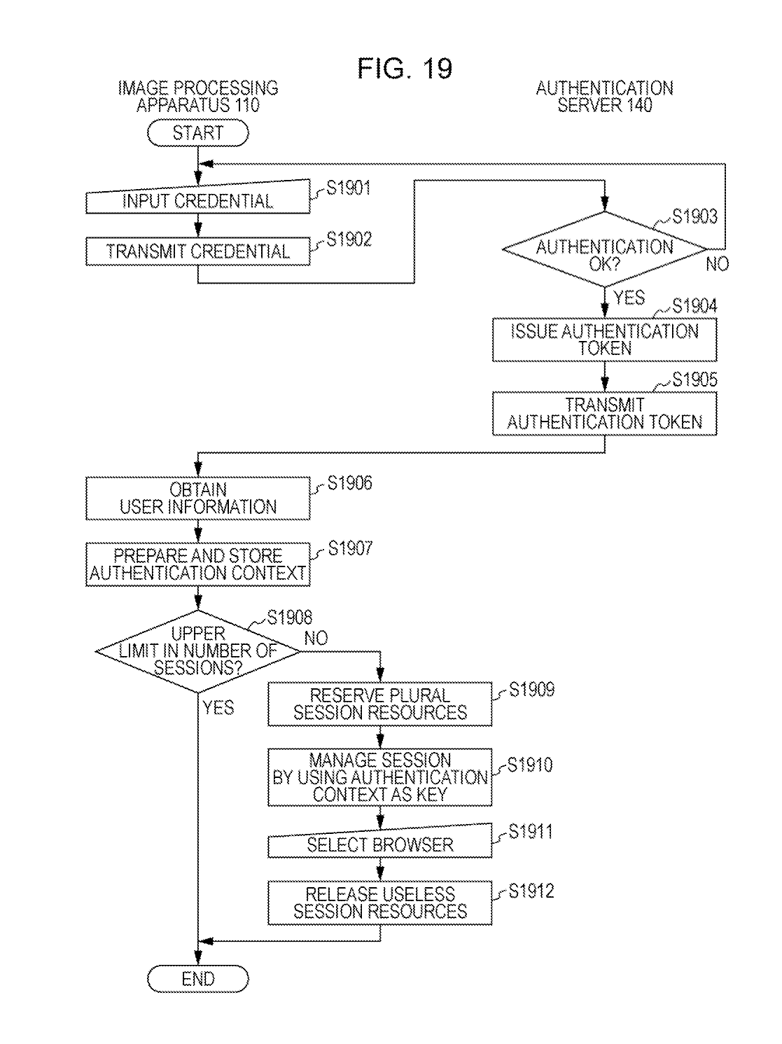

A fourth embodiment will be described below with reference to a flowchart of FIG. 19.

FIG. 19 is a flowchart illustrating one example of data processing procedures in an image processing system according to the fourth embodiment. The illustrated example represents data processing executed between the image processing apparatus 110 and the authentication server 140 when the user authentication process is executed by using the authentication server 140. In FIG. 19, S1901, S1902, and S1906 to S1912 are realized with the CPU 301 of the image processing apparatus 110 by loading the relevant modules in the RAM 302 and executing them. The following description is made only about the difference in comparison with the first embodiment.

In S1909, the SM 204 reserves resources for a plurality of sessions 1200. In S1910, the SM 204 stores a value of the session ID attribute 1203 for each of the plural reserved sessions 1200 as a value of the session ID reference attribute 914 in the authentication context that has been prepared in S1907.

As a result, the plural sessions 1200 can be each accessed by using the authentication context as a key. Further, the SM 204 stores the “resource reserved state” in the session state attribute 1206 of the session 1200. In addition, the SM 204 sets a flag at the first bit of the session type attribute 1204 of the session 1200.

If the user authentication has succeeded, the manipulating portion 112 of the image processing apparatus 110 displays, as a default screen, an application select screen (not shown). The user can utilize the desired one of applications, such as copy, fax, and browser, by selecting it.

In S1911, the user selects the browser application. In S1912, the SM 204 releases the useless session resources since the system and/or process no longer have a need for such session resources once the browser application is selected. Here, after the reserving unit has reserved the session, a releasing unit may release the useless resources depending on a process selected through the user interface. The processing is then brought to an end.

Thus, when the user authentication is executed through the manipulating portion 112 of the image processing apparatus 110, a plurality of session resources are previously reserved by using the user authentication information as a key. When the necessary session resource is determined (i.e., when an application is selected), the other session resources than the necessary one is released. As a result, an external processing request instructed by the user in front of the image processing apparatus 110 can be reliably executed.

### OTHER EMBODIMENTS

Aspects of the present invention also can be realized by a computer of a system or apparatus (or devices such as a CPU or MPU) that reads out and executes a program recorded on a memory device to perform the functions of the above-described embodiment(s). Aspects of the present invention also can be realized by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-156890 filed Jul. 1, 2009, which is hereby incorporated by reference herein in its entirety.

What is claimed is:

1. A data processing apparatus configured to be connected to an external apparatus via a network, the data processing apparatus comprising:
a display unit configured to obtain and display a user interface held in the external apparatus;
a receiving unit configured to receive, from a user manipulating the data processing apparatus, an instruction via the user interface displayed by the display unit;
an instruction transmitting unit configured to transmit the instruction received by the receiving unit to the external apparatus;
a reserving unit configured to reserve a session for communicating with the external apparatus when a process to authenticate the user manipulating the data processing apparatus has succeeded; and
a control unit configured to use the session reserved by the reserving unit to execute control to receive from the external apparatus a processing request that corresponds to the instruction transmitted to the external apparatus by the instruction transmitting unit.

2. The data processing apparatus according to claim 1, wherein the process to authenticate the user is executed to allow the user to use the data processing apparatus.

3. The data processing apparatus according to claim 1, wherein the process to authenticate the user is executed by an external authentication server that is connected to the data processing apparatus via the network.

4. The data processing apparatus according to claim 1, further comprising a reading unit configured to read an image on an original document,
wherein the processing request includes a request to the reading unit to engage in a reading process.

5. The data processing apparatus according to claim 1, wherein the reserving unit reserves a resource for the session when one of an authentication of the user and selection of an application is executed.

6. The data processing apparatus according to claim 1, further comprising a releasing unit configured to release useless resources depending on a process selected through the user interface after the reserving unit has reserved the session.

7. The data processing apparatus according to claim 6, wherein when a number of sessions reserved by the reserving unit is at least equal to a predetermined value, the releasing unit releases a session with a lower priority.

8. A control method for controlling a data processing apparatus configured to be connected to an external apparatus via a network, the control method comprising:
obtaining and displaying a user interface held in the external apparatus;
receiving, from a user manipulating the data processing apparatus, an instruction via the displayed user interface;
transmitting the received instruction to the external apparatus;
reserving a session for communicating with the external apparatus when a process to authenticate the user manipulating the data processing apparatus has succeeded; and
using the reserved session to execute control to receive from the external apparatus a processing request that corresponds to the instruction transmitted to the external apparatus.

9. A computer readable storage medium having stored thereon a computer executable program for controlling a data processing apparatus configured to be connected to an external apparatus via a network, the computer program comprising:
a code to obtain and display a user interface held in the external apparatus;
a code to receive, from a user manipulating the data processing apparatus, an instruction via the displayed user interface;
a code to transmit the received instruction to the external apparatus;
a code to reserve a session for communicating with the external apparatus when a process to authenticate the user manipulating the data processing apparatus has succeeded; and
a code to use the reserved session to execute control to receive from the external apparatus a processing request that corresponds to the instruction transmitted to the external apparatus.
